(19) United States
(12) Patent Application Publication
(10) Pub. No.: US 2002/0193493 A1
(43) Pub. Date: Dec. 19, 2002

(54) Method of making a product from an expanded mineral

(76) Inventor: Michael Windsor Symons, Pretoria (ZA)

Correspondence Address: PILLSBURY WINTHROP, LLP, P.O. BOX 10500, MCLEAN, VA, 22102, US

(21) Appl. No.: 10/168,183

(22) PCT Filed: Dec. 28, 2000
(86) PCT No.: PCT/IB00/01971

(30) Foreign Application Priority Data
Jan. 13, 2000 (ZA) 2000/0120
Feb. 22, 2000 (ZA) 2000/0858

(51) Int. Cl. C08K 3/34

(52) U.S. Cl. 524/442

(57) ABSTRACT

A method of making a finished product such as a building board includes the steps of forming a mixture of an expanded mineral such as exfoliated vermiculite and a thermosetting resin, pressing the mixture at a temperature in the range of from 100 to 220° C. inclusive to form a green product with a density in the range of from 200 to 650 kg/m³ inclusive, firing the green product in a kiln to its transition temperature to burn off substantially all of the organic constituents of the green product and thereby establish inorganic induced coherence to form the finished product, and allowing the finished product to cool.

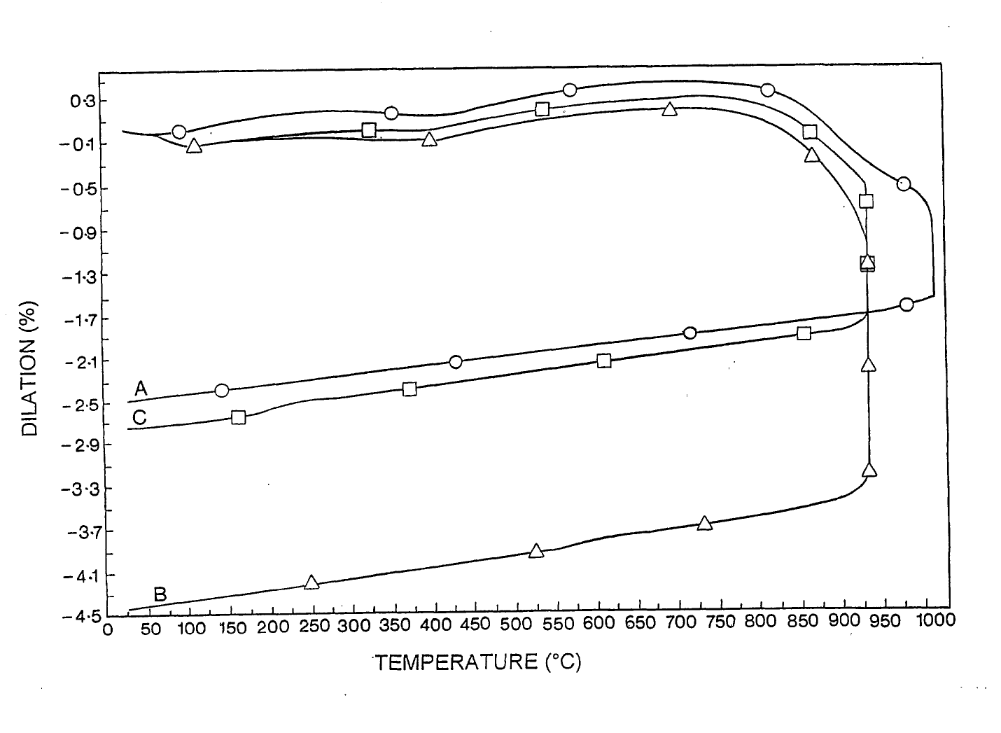

### BACKGROUND OF THE INVENTION

This invention relates to a method of making a product from an expanded mineral, and the product so made.

Refractory insulators used in domestic appliances, as well as products used principally in buildings to protect them against fire, are well known. Well known products of this kind, however, often suffer from a number of disadvantages. For instance, many products of this type suffer from cracking under service conditions, contain ceramic or other mineral fibres, which in certain circumstances can be undesirable, or are manufactured by wet processing in a water medium, which can also have disadvantages.

There is therefore a need for a new method of manufacturing composites resistant to high temperature.

### SUMMARY OF THE INVENTION

According to a first aspect of the invention, there is provided a method of making a finished product including the steps of:

a) forming a mixture of:

i) an expanded mineral in an amount of from 85% to 98% inclusive by mass of the total mass of components (i) and (ii); and

ii) a thermosetting resin in an amount of from 2% to 15% inclusive by mass of the total mass of components (i) and (ii);;

b) pressing the mixture at a temperature in the range of from 100° C. to 220° C. inclusive to form a green product with a density in the range of from 200 to 650 kg/m³ inclusive;

c) firing the green product in a kiln to its transition temperature to burn off substantially all of the organic constituents of the green product and thereby establish inorganic induced coherence to form the finished product; and

d) allowing the finished product to cool.

It is to be noted that the finished product is formed substantially in the absence of any extraneous liquid or gas that would make the pressing of the green product impractical at elevated temperatures. It is to be further noted that the initial cohesion of the green product is achieved by using a thermosetting resin whilst the firing of the green product to burn off any carbon containing constituents, including the thermosetting resin, results in a cohesive bond being established by the inorganic constituents, particularly those subjected to their transition temperature.

The transition temperature of the green product is the temperature at which burning off of the organic constituents is complete and sintering of the inorganic constituents has just commenced. In general the green product is heated in the kiln from ambient temperature up to its transition temperature of from 900° C. to a maximum of 1100° C. to achieve the desired result.

The firing temperature of the green product is preferably such as to allow a dilation percentage, i.e volume reduction of the green product to the fired finished product of not more than 7%.

The expanded mineral is preferably provided in the form of particles whilst the thermosetting resin may be provided in either a liquid or a dry powder form.

It is to be noted that the term “thermosetting resin” is intended to include the resins per se, as well as those components which may be regarded as precursors of the resins.

The thermosetting resin is preferably selected from the group comprising:

i) an MDI or urethane pre-polymer, typically dispersed in a mineral oil, vegetable oil or water, which is evaporated or removed before step (b);

ii) a phenol-formaldehyde resole resin dissolved in a low carbon alcohol such as methyl alcohol, optionally including a further solvent such as, for example, acetone, to which is added an acid catalyst, the alcohol and other solvent if present being evaporated or removed before step (b);

iii) a phenol-formaldehyde novolac resin in finely divided dry powder form and containing a catalyst for the resin, preferably hexamethylenetetramine, which dry powder is either dispersed in a fine particle size inorganic extender, or mixed with a volumetric extender in conditions that induce electrostatic attraction, or induced to adhere to the expanded mineral particles with an adhesion promoter, all to prevent separation from the mixture; and

iv) a urea formaldehyde resin, acid catalysed in water.

The method preferably includes in step (a) the addition into the mixture of a volumetric extender in order to increase the compression ratio between the laid up height before pressing and the post pressed green product height. The compression ratio is preferably increased so as to exceed 1.25:1, in particular to exceed 2.5:1, thereby to produce a green product in a density range of from 200 to 650 kg/m³ inclusive, preferably in the range of from 200 to 450 kg/m³ inclusive.

The volumetric extender is preferably selected from the following:

i) a milled thermoplastic resin foam such as, for example, a polyvinyl chloride or polystyrene (preferably to give irregular shaped particles); or

ii) a milled thermoset resin foam such as for example a phenol-formaldehyde resole resin foam which is either closed or open cell, or a medium to high density flexible to semi-rigid polyurethane foam (preferably to give irregular shaped particles).

The selected volumetric extender preferably has a bulk density range of from about 50 g/liter to a maximum of about 150 g/liter and a particle size of from about 100 micron to about 1 mm diameter inclusive. As a result, it also serves to increase the apparent porosity of the finished product when burnt off during the firing operation in step (c). The thermosetting resin foams are capable of withstanding temperatures in excess of 140° C., which temperature may be reached in step (b).

The method may also include in step (a) the addition into the mixture of an organic additive which comprises fine lignocellulosic particles, preferably of a particle size of 40 to 200 mesh inclusive, such as finely milled flours, e.g wheat or corn flours. These fine particles are burnt out during the firing of the green product in step (c) so that apparent porosities in excess of 75% can be achieved in the final product.

The method may include in step (a) the addition of an auxilliary inorganic binder to propagate the coherence of the particles of the expanded mineral during or after the burning off of the thermosetting resin.

The auxiliary inorganic binder is preferably an alkali silicate such as, for example sodium silicate or potassium silicate in dry powder form.

In place of the use of such an alkali silicate, as described above, the method of the invention may include the following step:

(e)—either after step (b) and before step (c), or after step (c) impregnating the green product or the product of step (c) with a silicate solution selected from the group consisting of sodium silicate, potassium silicate, and ethyl silicate.

Preferably, the green product is impregnated before step (d), in order to remove the organic constituents when using ethyl silicate, or water when using sodium or potassium silicate, during firing before the product is put to use.

The use of such a silicate, after the removal of the volatiles, forms a glassy interface between the expanded mineral particles, which improves the cohesive strengths and the ability of the finished product to withstand shipping and handling.

The method may include in step (a) the addition of finely divided inorganic particles, preferably of the clay family, the selected particles preferably having a refractory contribution as well as a contribution to the physical characteristic of the finished product such as, for example, dimensional stability and shock resistance. They also preferably control the dilation percentage to temperature relationship to avoid precipitous collapse of the composite during firing, by making the transition point more gradual. They are thus, typically, chosen from inorganic refractory candidates including kaolin, bentonite, talc, fused silica, zirconium flyash, granulated blast furnace slag and the like.

The additional components of the mixture, i.e. the volumetric extender, the auxiliary inorganic binder, the fine lignocellulosic particles and the finely divided inorganic particles may comprise up to 35% by mass of the total mass of the mixture. Thus, for example, the mixture may comprise up to 35% by mass of a volumetric extender alone, or up to 35% by mass of a combination of a volumetric extender and finely divided inorganic particles.

According to a second aspect of the invention there is provided a finished product made by the method set out above.

### BRIEF DESCRIPTION OF THE DRAWINGS

The accompanying drawing is a graph of dilation v temperature showing the effect of the presence and/or absence of inorganic extenders in vermiculite based refractory composites.

### DESCRIPTION OF PREFERRED EMBODIMENTS

The crux of the invention is a method of making a finished product resistant to high temperatures which is characterised by having a high thermal insulation, dimensional stability (even when subjected to thermal shock in the range of ambient to 800° C. repeated continuously over long periods), a low coefficient of thermal expansion, a low density and a high percentage of apparent porosity.

The finished product is made by a method of binding an expanded mineral with a thermosetting resin, pressing it at an elevated temperature and pressure, and firing the resulting low density green composite to its transition temperature to burn off the organic constituents, thereby producing a finished product bound inorganically as a ceramic suitable for fire protection and refractory insulation.

The first component of the mixture is an expanded mineral. Vermiculite, which is the geological name for a group of hydrated lamina minerals that are aluminum iron magnesium silicates in the mica and/or clay family, is by far the preferred expanded mineral. When subjected to heat of the order of 900° C. it exfoliates due to the interlamina release of water of crystallisation. Vermiculite is inert, chemically pure, non-carcinogenic, free from asbestos if from the right sources, non-corrosive, non-combustible, non-allergenic, odourless and harmless if swallowed. Depending on the source, it has a melt point of 1 315° C. and a sinter temperature in the order of 1 260° C. It has a thermal conductivity of K=0.062 to 0.065 w/m° C. It is preferably used in the method of the invention in exfoliated form and having particle sizes of from less than 0.5 mm to 3 mm diameter inclusive.

It would in the normal course have been reasonable to expect that when vermiculite is pressed to a board density in the range of 450 kg/m³ to 650 kg/m³, using a novolac resin at between 5% and 8% of the composition by weight, in the temperature range of 150° C. to 200° C., and subsequently fired to a temperature of 950° C. to bum off the binder, the composite would have no integrity. On the contrary, it has surprisingly been found that the board retains its cohesion and shows remarkable dimensional stability. For example, a green board of density of 490 kg/m³ with an apparent porosity percentage of 77.5% and a modulus of rupture of 0.65 mPa was fired at a temperature of 960° C. and allowed to cool. Subsequently it was subjected to thermal shock cycles of between 22° C. and 800° C. repeatedly for five rapid cycles, whereupon no dimensional change was noticeable. In addition, the post-treated modulus of rupture remained at 0.65 mPa and the board had not warped, cracked or deteriorated in any way.

Another suitable expanded mineral is expanded perlite with a particle size of nil retained on a 45 micron screen up to a mean particle size of 550 micron, or a mixture of exfoliated vermiculite and expanded perlite.

The second component in the mixture is a thermosetting resin. The thermosetting resin may be selected from:

i) an MDI or urethane pre-polymer dispersed either in a mineral or vegetable oil or in water, which is subsequently allowed to evaporate or is removed;

An example is Duthane 2447 by Industrial Urethanes.

ii) a phenol-formaldehyde novolac resin;

An example is Code 622 by Schenectady Corporation.

iii) a phenol-formaldehyde resole resin, extended with a low carbon alcohol and post acid catalysed;

An example is J2018L by Borden Chemical Corporation.

iv) a urea formaldehyde resin with an acid catalyst in a water medium.

When the thermosetting resin (component (ii)) is a phenol formaldehyde novolac resin, it has been found preferable to utilise an adhesion promoter to adhere the resin to the expanded mineral particles. For example, the expanded mineral particles may be wetted with a polyvinyl alcohol solution in water such as for example a 3% to 10% solution of an 85% to 88% hydrolysed polyvinyl alcohol in water, i.e 4188 Mowiol by Clariant at an amount of between 10% and 30% by mass on the mass of the expanded mineral particles, to damp the expanded mineral particles. An alternative adhesion promoter is a solution of potassium silicate. Thereafter the particles of the phenol formaldehyde novolac resin may be added and adhered to the expanded mineral particles. The mixture is then dried and pressed to make the green product according to the method of the invention. It has been found that utilising this procedure results in no resin separation from the expanded mineral particles.

The mixture contains the expanded mineral in an amount of from 85% to 98% inclusive by mass of the total mass of components (i) and (ii), i.e the expanded mineral and the thermosetting resin, and the thermosetting resin in an amount of from 2% to 15% inclusive by mass of the total mass of components (i) and (ii).

It has been found that a board bound by such a thermosetting resin, when pressed to a density of between 450 kg/m³ and 650 kg/m³, at temperatures between 140° C. and 220° C., fired at a temperature in the range of 900° C. to 1100° C. and then allowed to cool, can be used as a refractory insulator in domestic appliances, or in fire protection in specialised applications, as a stable ceramic.

Vermiculite on its own in the composition has the limitation that densities below 450 kg/m³ may not be achievable without the resulting product having unacceptable cohesion. There may therefore be the need for a volumetric extender in the composition, so that the bulk density of the dry laid up furnish before pressing allows compression ratios greater than about 1.25:1, more preferably greater than about 2.5:1, on pressing. Thus boards of densities of 200 kg/m³ to 450 kg/m³ may be produced with the necessary cohesive strength both before and after firing. In addition, when organic volumetric extenders are used they are burnt off during firing thereby increasing the porosity and reducing the density of the product. In addition, when using organic volumetric extenders, because of their very low bulk densities, the method of milling is important. It is important that the particles are rough with jagged edges, so that when mixing with the other components of the furnish, they do not separate and move to the surface.

The volumetric extenders added to the mixture are preferably chosen from the following:

i) milled thermoplastic resin foams such as, for example, polyvinyl chloride or polystyrene; and

ii) milled thermoset resin foams such as, for example, phenol-formaldehyde resoles or polyurethanes.

Other additives may also be added into the mixture.

For example, the method may also include in step (a) the addition into the mixture of an organic additive which comprises fine lignocellulosic particles, preferably of a particle size of from 40 to 200 mesh inclusive, such as finely milled flours, e.g wheat or corn flours. These fine particles are burnt out during the firing of the green product in step (c) so that apparent porosities in excess of 75% can be achieved in the final product.

Alternatively, the method may include in step (a) the addition of an auxiliary inorganic binder to propagate the coherence of the particles of the expanded mineral during or after the burning off of the thermosetting resin.

The auxiliary inorganic binder may be an alkali silicate, such as potassium silicate or sodium silicate in dry powder form.

In place of the use of such an alkali silicate, the method may include the step of:

(e) either after step (b) and before step (c), or after step (c) impregnating the green product or the product of step (c) with a silicate solution selected from sodium silicate, potassium silicate and ethyl silicate.

The preferred silicate is a solution of ethyl silicate, for example a pre-hydrolysed ethyl silicate hybrid binder, containing between 5% and 25% by weight of the reactive silicate. Such a binder consists principally of pre-hydrolysed silicic acid ester binding agents in ethanol/proponol or prehydrolysed ethyl silicate. Specific examples of these are Silester AR, Silester XAR, and Silester X15, by Wacker. Further examples are Wacker silicate MT220 or GH02, which are pre-hydrolysed ethyl silicates, or Wacker silicates TES28 or TES40, which are unhydrolysed monomeric ethyl silicates which must be catalysed, or a mixture of monomeric and various condensed ethyl silicates, respectively.

Examples of a potassium silicate solution are Silchem K2166 by Silicate & Chemical Industries, with a composition of SiO₂ of 23.86% and of K₂O of 11.11%, and Silchem K1420 with a composition of SiO₂ of 30.7% and of K₂O of 21%.

Since the silicate also serves as a fluxing agent to the composition, it maintains firing temperatures below 1 200° C., preferably in the range of 900° C. to 1000° C., so that the resulting ceramic may be fit for services in the temperature range below 900° C. In order to control dilation, preferably to a dilation percentage not greater than 7%, at the transition temperature it is necessary to spread transition over a wider temperature range. For this purpose further refractory contributors are typically added. These are chosen preferably from kaolin, talc, bentonite, fused silica, zirconium, or refractory extenders. In the absence of inorganic additives preferably containing a sufficiency of aluminum oxide and silica, dilation may be across too narrow a temperature range and result in precipitous collapsing of the composite. This is shown on the dilation/temperature graphs depicted in the accompanying drawing in respect of three compositions. Sample (a) is pure vermiculite, sample (c) contains perlite and shows the presence of crystobolite in the cooling range 200° C. to 250° C., which will result in unacceptable internal stress, and sample (b) has no inorganic refractory extenders exhibiting the undesirable phenomenon described above i.e. too great a dilation over too narrow a temperature range which can result in sensitive limits in the production process.

The additional components of the mixture, viz the volumetric extender, the auxiliary inorganic binder, the fine lignocellulosic particles and the finely divided inorganic particles may comprise up to 35% by mass of the total mass of the mixture.

In step (a) of the method of the invention, there is formed a mixture of the expanded mineral, the thermosetting resin, and any additional components such as for example the volumetric extender. The mixture may be formed in any suitable manner, for example simply by dry mixing the ingredients in a suitable mixer.

In step (b) of the method of the invention, the mixture is pressed at a temperature in the range of from 100° C. to 220° C. inclusive, and preferably at a pressure of from 7 to 15 kg/cm² inclusive, for example between the platens of a press, to form a green product with a density in the range of from 200 to 650 kg/m³ inclusive.

For example, the mixture of step (a) may be laid up to a suitable height on a platen of a press, and then pressed with a second platen, at suitable temperatures and pressures, to form the green product.

In step (c), the green product of step (b) is fired in a kiln, for example a continuous kiln, to its transition temperature to burn off substantially all of the organic constituents of the green product and thereby establish inorganic induced coherence to form the finished product. The transition temperature of the green product is the temperature at which burning off of the organic constituents is complete and sintering of the inorganic constituents has just commenced. In general, the green product is heated in the kiln from ambient temperature up to its transition temperature of from 900° C. to a maximum of 1100° C. to achieve the desired result.

In step (d) of the method of the invention, the finished product is allowed to cool.

The second aspect of the invention is a finished product produced as described above.

### EXAMPLE

An example of a finished product made by the method of the invention will now be given.

A. The following constituents were dry mixed:

Zonolite No. 5 Exfoliated Vermiculite by WR Grace 700 kg

Sodium di-silicate code P10 by Crosfield of bulk density 80-120 g/liter 15 kg

Novolac phenol formaldehyde dry powder resin with catalyst Durite AD 323T by Borden Chemical Company 110 kg

Kaolin 300 mesh 12 kg

Milled phenol formaldehyde resole resin foam of density 25 kg/m 150 kg

B. The mixture was then laid up at a thickness of about 30 mm with a mass per square centimeter of 0.30 grams and pressed at 180° C. to a thickness of 10 mm.

C. The 30 kg/m³ resulting ‘green’ board was trimmed and then fired at a temperature of up to 930° C. for about 30 minutes.

D. The finished product was cooled.

It was found that the finished product was suitable for use as either a domestic appliance refractory insulation or as a fire rated ceramic building board.

1 A method of making a finished product including the steps of:
a) forming a mixture of:
i) an expanded mineral in an amount of from 85% to 98% inclusive by mass of the total mass of components (i) and (ii); and
ii) a thermosetting resin in an amount of from 2% to 15% inclusive by mass of the total mass of components (i) and (ii);
b) pressing the mixture at a temperature in the range of from 100° C. to 220° C. inclusive to form a green product with a density in the range of from 200 to 650 kg/m³ inclusive;
c) firing the green product in a kiln to its transition temperature to burn off substantially all of the organic constituents of the green product and thereby establish inorganic induced coherence to form the finished product; and
d) allowing the finished product to cool.

2 A method according to claim 1 wherein in step (a) the thermosetting resin is selected from the group consisting of:
i) an MDI or urethane pre-polymer, dispersed in a mineral oil, vegetable oil or water, which is evaporated or removed before step (b);
ii) a phenol-formaldehyde resole resin dissolved in a solvent, to which is added an acid catalyst, the solvent being evaporated or removed before step (b);
iii) a phenol-formaldehyde novolac resin in finely divided dry powder form and containing a catalyst for the resin; and
iv) a urea formaldehyde resin acid catalyzed in water.

3 A method according to claim 1 or claim 2 wherein in step (a) the expanded mineral is selected from the group consisting of exfoliated vermiculite, expanded perlite and a mixture thereof.

4 A method according to claim 3 wherein in step (a) the exfoliated vermiculite has a particle size of from less than 0.5 mm to 3 mm diameter inclusive.

5 A method according to claim 3 or claim 4 wherein in step (a) the expanded perlite has a particle size of nil retained on a 45 micron screen up to a mean particle size of 550 micron.

6 A method according to any one of claims 1 to 5 wherein in step (a) there is included in the mixture a volumetric extender.

7 A method according to claim 6 wherein in the volumetric extender is selected from the group consisting of:
i) a milled thermoplastic resin foam; and
ii) a milled thermoset resin foam

8 A method according to any one of claims 1 to 7 wherein in step (a) there is included in the mixture an organic additive comprising fine lignocellulosic particles.

9 A method according to any one of claims 1 to 8 wherein in step (a) there is included in the mixture an auxiliary inorganic binder to propagate the coherence of the particles of the expanded mineral during or after the burning off of the thermosetting resin.

10 A method according to any one of claims 1 to 9 wherein in step (a) there is included in the mixture finely divided inorganic particles.

11 A method according to any one of claims 6 to 10 wherein the volumetric extender and/or the auxiliary inorganic binder and/or the fine lignocellulosic particles and/or the finely divided inorganic particles together comprise up to 35% by mass of the total mass of the mixture.

12 A method according to any one of claims 1 to 8 and 10 wherein the method includes the step of:
(e) either after step (b) and before step (c) or after step (c) impregnating the green product or the product of step (c) with a silicate solution selected from the group consisting of sodium silicate, potassium silicate and ethyl silicate.

13 A method according to any one of claims 1 to 12 wherein in step (c) the green product is heated in the kiln to its transition temperature of 900° C. up to a maximum of 1100° C.

14 A finished product comprising an expanded mineral bound with a thermosetting resin which is made by a method including the steps of:
a) forming a mixture of:
i) an expanded mineral in an amount of from 85% to 98% inclusive by mass of the total mass of components (i) and (ii); and
ii) a thermosetting resin in an amount of from 2% to 15% inclusive by mass of the total mass of components (i) and (ii);
b) pressing the mixture at a temperature in the range of from 100° C. to 220° C. inclusive to form a green product with a density in the range of from 200 to 650 kg/m³ inclusive;
c) firing the green product in a kiln to its transition temperature to burn off substantially all of the organic constituents of the green product and thereby establish inorganic induced coherence to form the finished product; and
d) allowing the finished product to cool.
